(19) United States
(12) Patent Application Publication
(10) Pub. No.: US 2018/0342893 A1
(43) Pub. Date: Nov. 29, 2018

(54) POWER SUPPLY

(71) Applicant: FUJI ELECTRIC CO., LTD., Kanagawa (JP)

(72) Inventors: Ryuji YAMADA, Hachioji-city (JP); Koji KAWAGUCHI, Chigasaki-city (JP)

(21) Appl. No.: 15/936,336

(22) Filed: Mar. 26, 2018

(30) Foreign Application Priority Data
May 23, 2017 (JP) 2017-101589

(51) Int. Cl. H02J 9/06; H02M 3/155; H02H 7/10; H02M 7/06; H02M 7/217; H02M 1/32

(52) U.S. Cl. CPC H02J 9/062; H02M 3/155; H02M 1/32; H02M 7/06; H02M 7/217; H02H 7/10

(57) ABSTRACT

A power supply device including: a positive-side and negative-side capacitors sequentially connected between a positive-side and negative-side output-terminal; a positive-side and negative-side semiconductor switches sequentially connected between the positive-side and negative-side output-terminal in parallel to the positive-side and negative-side capacitors; and a plurality of rectifying circuits, each of which has an AC input-terminal and rectifies current flowing between the AC input-terminal and the positive-side and negative-side output-terminal is provided. Each of a plurality of rectifying circuits has a positive-side rectifier which is; connected between an AC input-terminal and a positive-side output-terminal; is able to control a forward conduction state from the AC input-terminal side toward the positive-side output-terminal side; and blocks reverse current, and a negative-side rectifier which: is connected between an AC input-terminal and a negative-side output-terminal; is able to control a forward conduction state from the negative-side output-terminal side toward the AC input-terminal side; and blocks reverse current.

The contents of the following Japanese patent application are incorporated herein by reference:

No. 2017-101589 filed in JP on May 23, 2017.

### BACKGROUND

### 1. Technical Field

The present invention relates to power supply devices.

### 2. Related Art

Uninterruptible power supplies are known as devices for supplying constant power to a load, even if instantaneous voltage sag of a commercial power supply, or a power failure or the like occurs. They are what supply power during a power failure with a power storage device of a battery or the like (for example, refer to Patent Documents 1 and 2).

Generally, a power storage device of a battery or the like has many weak points, e.g., it takes up large space and is expensive, it has a shorter life than most electrical components, and it requires maintenance on a regular basis. Therefore, the following methods have been suggested: a method for receiving power from equal to or more than two independent power systems and switching to another power system at a time of a power failure or the like, in order to realize no power failure without using a battery or the like; and a method for enabling to switch between an AC system and an uninterruptible power supply, or between outputs of a plurality of uninterruptible power supplies, in order to further improve reliability even when using an uninterruptible power supply such as a battery (for example, refer to Patent Documents 3-5).

Patent Document 1: Japanese Patent Application Publication No. H9-107681.

Patent Document 2: Japanese Patent Application Publication H5-161359.

Patent Document 3: Japanese Unexamined Utility Model Application No. H6-29351.

Patent Document 4: Japanese Patent Application Publication No. 2004-56888.

Patent Document 5: Japanese Patent Application Publication No. 2013-162711.

Thyristors are used for switching of a method described in Patent Document 3, however, they cannot self-turn-off, and this characteristic of thyristors causes instantaneous interruption of approximately a few ms at a time of the switching. Semiconductor devices which can self-turn-off may be used too, however, resistance to overcurrent will be reduced and a loss may be large. A complex configuration is described in Patent Document 4 for a method which requires heavy transformers that take up large space.

### SUMMARY

To solve the above-mentioned problems, a power supply device is provided in a first aspect of the present invention. The power supply device may include a positive-side capacitor and a negative-side capacitor which are sequentially connected between a positive-side output-terminal and a negative-side output-terminal. The power supply device may include a positive-side semiconductor switch and a negative-side semiconductor switch which are sequentially connected between the positive-side output-terminal and the negative-side output-terminal, and are parallel to the positive-side capacitor and the negative-side capacitor. The power supply device may include a plurality of rectifying circuits each of which has an AC input-terminal, and rectifies current flowing between the AC input-terminal, and a positive-side output-terminal and a negative-side output-terminal. Each of the plurality of rectifying circuits may have a positive-side rectifier which: is connected between the AC input-terminal and the positive-side output-terminal; can control a forward conduction state from AC input-terminal side toward positive-side output-terminal side; and blocks reverse current. Each of the plurality of rectifying circuits may have a negative-side rectifier which: is connected between the AC input-terminal and the negative-side output-terminal; can control a forward conduction state from negative-side output-terminal side toward AC input-terminal side; and blocks reverse current.

Each of the plurality of rectifying circuits may have a positive-side control terminal to control a forward conduction state of the positive-side rectifier, and a negative-side control terminal to control a forward conduction state of the negative-side rectifier. The power supply device may further include a control circuit to control the positive-side control terminal and the negative-side control terminal of each of a plurality of rectifying circuits.

In order to cause forward direction conduction in the positive-side rectifier and the negative-side rectifier of a first rectifying circuit among a plurality of rectifying circuits to which AC power to use is inputted, the control circuit may control a positive-side control terminal and a negative-side control terminal of the first rectifying circuit.

If the AC power to use is switched from a first AC power that is to be inputted into the first rectifying circuit to a second AC power that is to be inputted into a second rectifying circuit among a plurality of rectifying circuits, the control circuit: may control the positive-side control terminal and the negative-side control terminal of the first rectifying circuit, in order to block forward direction conduction in the positive-side rectifier and the negative-side rectifier of the first rectifying circuit; and may control a positive-side control terminal and a negative-side control terminal of the second rectifying circuit, in order to cause a forward direction conduction state in a positive-side rectifier and a negative-side rectifier of the second rectifying circuit.

The control circuit may switch the AC power to use, asynchronously with the AC power that is to be inputted into the first rectifying circuit and the AC power that is to be inputted into the second rectifying circuit.

The plurality of rectifying circuits may input the AC power from different AC power supplies. The control circuit may switch the AC power to use among some AC power that is to be inputted into the plurality of rectifying circuits, based on a predetermined schedule.

The power supply device may include a set of the positive-side semiconductor switch, the negative-side semiconductor switch and the plurality of rectifying circuits, corresponding to each phase of some multi-phase AC power.

The positive-side rectifier and the negative-side rectifier of each of the plurality of rectifying circuits may be thyristors.

The control circuit may control the positive-side control terminal of the rectifying circuit that inputs the AC power to use among the plurality of rectifying circuits, in order to cause forward direction conduction in the positive-side rectifier in at least a part of a period in which the AC power is a positive voltage, and in order to block forward direction conduction in the positive-side rectifier in at least a part of a period in which the AC power is a negative voltage. The control circuit may control the negative-side control terminal of the rectifying circuit that inputs the AC power to use among the plurality of rectifying circuits, in order to cause forward direction conduction in the negative-side rectifier in at least a part of a period in which the AC power is a negative voltage, and in order to block forward direction conduction in the negative-side rectifier in at least a part a period in which the AC power is a positive voltage.

The power supply device may include a positive-side inductor connected between the plurality of rectifying circuits and the positive-side output-terminal. The power supply device may include a negative-side inductor connected between the plurality of rectifying circuits and the negative-side output-terminal.

The power supply device may further include an input side inductor which: is provided corresponding to each of the plurality of rectifying circuits; and is connected between an AC power supply and an AC input-terminal both of which correspond to respective rectifying circuits.

The power supply device may further include a converting circuit which: is connected to the positive-side output-terminal and the negative-side output-terminal; and converts DC power to different DC power or AC power which are to be outputted from the positive-side output-terminal and the negative-side output-terminal.

The summary clause does not necessarily describe all necessary features of embodiments of the present invention. The present invention may also be a sub-combination of the features described above.

### BRIEF DESCRIPTION OF THE DRAWINGS

FIG. 1 illustrates a power supply device according to the embodiments.

FIG. 2 illustrates operations of the power supply device.

FIG. 3 illustrates operations of the power supply device in a situation where an AC power supply to use is switched.

FIG. 4 illustrates a control circuit according to the embodiments.

FIG. 5 illustrates operations of the power supply device in a situation where the AC power supply to use is switched.

FIG. 6 illustrates the power supply device according to a modification example.

FIG. 7 illustrates the power supply device according to a modification example.

FIG. 8 illustrates the power supply device according to a modification example.

### DESCRIPTION OF EXEMPLARY EMBODIMENTS

Hereinafter, embodiments of the present invention will be described. The embodiments do not limit the invention according to the claims, and not all the combinations of the features described in the embodiments are necessarily essential to means provided by aspects of the invention.

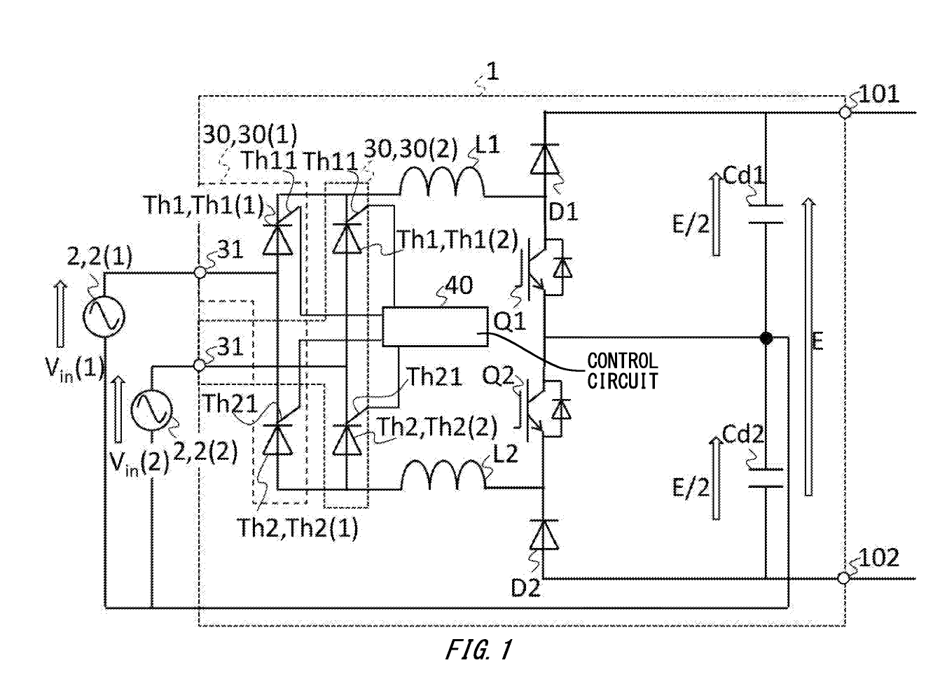

FIG. 1 illustrates a power supply device 1 according to the present embodiments, together with a plurality of AC power supplies 2. The outlined arrows of the drawing indicate a positive direction of voltage.

Each of the plurality of AC power supplies 2 can supply the power supply device 1 with AC power (single-phase AC power as an example, in the present embodiment). The plurality of AC power supplies 2 may be power supplies of the same type, or may be power supplies of different types. The power supplies of the same type may be, as an example, power supplies having the same voltage, current, frequencies, and phases. The power supplies of different types may be power supplies having the same as those above, except at least one of them is different from each other. Respective AC power supplies 2 may be commercial power supplies of separate power systems, or may be separate uninterruptible power supplies. In the present embodiment, as an example, the plurality of AC power supplies 2 is configured to include an AC power supply 2(1) to supply AC voltage Vᵢₙ(1), and an AC power supply 2(2) to supply AC voltage Vᵢₙ(2).

The power supply device 1 converts AC power supplied from one of the two AC power supplies 2 to DC power, and outputs it from a positive-side output-terminal 101 and a negative-side output-terminal 102. The power supply device 1 may be an uninterruptible DC power supply to maintain supply of DC power by switching the AC power supply 2 to use. The power supply device 1 includes a plurality of rectifying circuits 30, a positive-side capacitor Cd1 and a negative-side capacitor Cd2, a positive-side semiconductor switch Q1 and a negative-side semiconductor switch Q2, a positive-side diode D1 and a negative-side diode D2, a positive-side inductor L1 and a negative-side inductor L2, and a control circuit 40.

The plurality of rectifying circuits 30 has AC input-terminals 31 to which AC power is supplied from the AC power supply 2, and rectifies current flowing between the AC input-terminals 31, and the positive-side output-terminal 101 and the negative-side output-terminal 102. In the present embodiment, as an example, the plurality of rectifying circuits 30 has: a rectifying circuit 30(1) that is connected to the AC power supply 2(1) and receives supply of power; and a rectifying circuit 30(2) that is connected to the AC power supply 2(2) and receives supply of power. In the present embodiment, as an example, the AC input-terminals 31 are input-terminals of the power supply device 1. In addition to the AC input-terminals 31, respective rectifying circuits 30 have positive-side rectifiers Th1 (also referred to as positive-side rectifiers Th1(1) and Th1(2)) and negative-side rectifiers Th2 (also referred to as negative-side rectifiers Th2(1) and Th2(2)).

The positive-side rectifiers Th1 are connected between the AC input-terminals 31 and the positive-side output-terminal 101. The positive-side rectifiers Th1 can control a forward conduction state from AC input-terminals 31 side toward positive-side output-terminal 101 side, and block reverse current. Provided to the positive-side rectifiers Th1 are positive-side control terminals Th11 to control a forward conduction state of the positive-side rectifiers Th1. In the present embodiment, as an example, the positive-side rectifiers Th1 are thyristors and the positive-side control terminals Th11 are gates. In this case, if forward bias is applied to the positive-side rectifiers Th1 to turn on the positive-side control terminals Th11, the positive-side rectifiers Th1 fire to shift to a forward conduction state. Also, if the positive-side control terminals Th11 are turned off (gate-off), the positive-side rectifiers Th1 self-turn-off to shift to a forward blocking state at timing when AC power current becomes zero. Operation frequencies of the positive-side rectifiers Th1 are frequencies of AC power supplies, which often are 50 or 60 Hz.

The negative-side rectifiers Th2 are connected between the AC input-terminals 31 and the negative-side output-terminal 102. The negative-side rectifiers Th2 can control a forward conduction state from negative-side output-terminal 102 side toward AC input-terminal 31 side, and block reverse current. Provided to the negative-side rectifiers Th2 are negative-side control terminals Th21 to control a forward conduction state of the negative-side rectifiers Th2. In the present embodiment, as an example, the negative-side rectifiers Th2 are thyristors and the negative-side control terminals Th21 are gates. In this case, if forward bias is applied to the negative-side rectifier Th2 to turn on the negative-side control terminals Th21, the negative-side rectifiers Th2 fire to shift to a forward conduction state. Also, if the negative-side control terminals Th21 are turned off (gate-off), the negative-side rectifiers Th2 self-turn-off and shift to a forward blocking state at timing when AC power current becomes zero. Operation frequencies of the negative-side rectifier Th2 are frequencies of AC power supplies, which often are 50 or 60 Hz.

The positive-side capacitor Cd1 and the negative-side capacitor Cd2 are sequentially connected in series between the positive-side output-terminal 101 and the negative-side output-terminal 102. Each of the positive-side capacitor Cd1 and the negative-side capacitor Cd2 holds a voltage E/2. The middle point between the positive-side capacitor Cd1 and the negative-side capacitor Cd2 may be connected to one end of respective AC power supplies 2 (in the drawing, the bottom end).

The positive-side semiconductor switch Q1 and the negative-side semiconductor switch Q2 are sequentially connected between the positive-side output-terminal 101 and the negative-side output-terminal 102, and are parallel to the positive-side capacitor Cd1 and the negative-side capacitor Cd2. The middle point between the positive-side semiconductor switch Q1 and the negative-side semiconductor switch Q2 is connected to the middle point between the positive-side capacitor Cd1 and the negative-side capacitor Cd2. The positive-side semiconductor switch Q1 and the negative-side semiconductor switch Q2 may be IGBTs, MOSFETs, bipolar transistors, or the like. Operation frequencies of the positive-side semiconductor switch Q1 and the negative-side semiconductor switch Q2 are high frequencies, such as, for example, 10 kHz. The positive-side semiconductor switch Q1 and the negative-side semiconductor switch Q2 may have semiconductor switches composed of wide band gap semiconductors. Wide band gap semiconductors are semiconductors that have greater band gap than that of silicon semiconductors, and are semiconductors such as SiC semiconductors, GaN semiconductors, diamond semiconductors, AlN semiconductors, AlGaN semiconductors, ZnO semiconductors, etc.

The positive-side diode D1 and the negative-side diode D2 are connected between the positive-side semiconductor switch Q1 and the negative-side semiconductor switch Q2, and the positive-side output-terminal 101 and the negative-side output-terminal 102. In the present embodiment, as an example, an anode of the positive-side diode D1 may be connected to a positive-side terminal of the positive-side semiconductor switch Q1. Also, a cathode of the negative-side diode D2 may be connected to a negative-side terminal of the negative-side semiconductor switch Q2. The positive-side diode D1 and the negative-side diode D2 may have semiconductor switches composed of wide band gap semiconductors.

The positive-side inductor L1 is connected between two rectifying circuits 30 and the positive-side output-terminal 101. For example, the positive-side inductor L1 may be connected between a cathode of each positive-side rectifier Th1 (a thyristor, in the present embodiment) in the two rectifying circuits 30, and the positive-side semiconductor switch Q1 and the positive-side diode D1. The positive-side inductor L1 smoothes DC current generated by rectification performed by the rectifying circuits 30. Instead of/in addition to this, the positive-side inductor L1 boosts generated DC power.

The negative-side inductor L2 is connected between two rectifying circuits 30 and the negative-side output-terminal 102. For example, the negative-side inductor L2 may be connected between an anode of each negative-side rectifier Th2 (a thyristor, in the present embodiment) in the two rectifying circuits 30, and the negative-side semiconductor switch Q2 and the negative-side diode D2. The negative-side inductor L2 smoothes DC current generated by rectification performed by the rectifying circuits 30. Instead of/in addition to this, the negative-side inductor L2 boosts generated DC power.

The control circuit 40 controls each of the positive-side control terminal Th11 and the negative-side control terminal Th21 of the two rectifying circuits 30(1) and 30(2). The control circuit 40 controls the positive-side semiconductor switch Q1 and the negative-side semiconductor switch Q2.

According to the above described power supply device 1, each of the two rectifying circuits 30 is equipped with the positive-side rectifier Th1 connected between the AC input-terminal 31 and the positive-side output-terminal 101, and the negative-side rectifier Th2 connected between the AC input-terminal 31 and the negative-side output-terminal 102. The positive-side rectifier Th1 can control a forward conduction state from AC input-terminal 31 side toward positive-side output-terminal 101 side, and blocks reverse current. The negative-side rectifier Th2 can control a forward conduction state from negative-side output-terminal 102 side toward the AC input-terminal 31 side, and blocks reverse current. Accordingly, by using the positive-side rectifier Th1 and the negative-side rectifier Th2 of respective rectifying circuits 30, it is possible to appropriately switch to the AC power supply that is to be used, and supply power from this AC power supply without causing instantaneous interruption.

The positive-side inductor L1 is connected between the two rectifying circuits 30 and the positive-side output-terminal 101, and the negative-side inductor L2 is connected between the plurality of rectifying circuits 30 and the negative-side output-terminal 102. Accordingly, the positive-side inductor L1 can be made inactive while polarity of the AC power supply is in negative voltage half cycle, and the negative-side inductor L2 can be made inactive while polarity of the AC power supply is in positive voltage half cycle. Hence, the more heat generated is reduced due to an effective value of current flowing through inductors becoming 1.√2 of rated current, the smaller the positive-side inductor L1 and the negative-side inductor L2 can be, in comparison with a situation where inductors are connected between the rectifying circuit 30 and the AC power supply. Also, because there is no need to provide a inductor for each AC power supply 2, numbers of inductors can be two regardless of numbers of the AC power supplies 2.

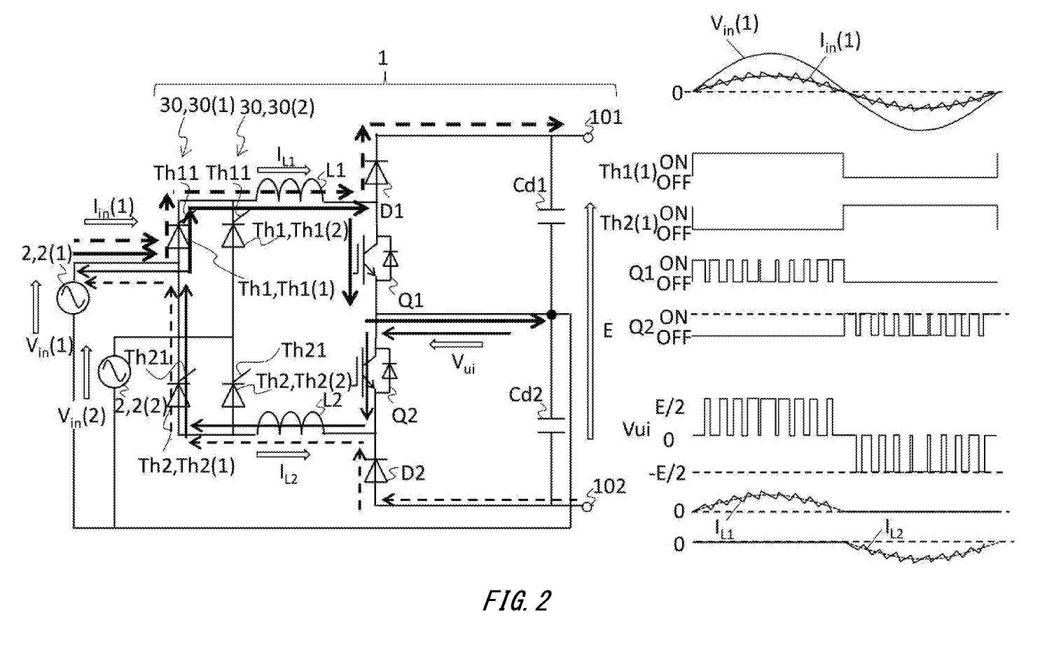

Next, operations of the power supply device 1 if AC power supply is sound (also referred to as when AC power supply is sound) will be described. FIG. 2 illustrates operations of the power supply device 1. Note that, in FIG. 2, an illustration for the control circuit 40 is omitted. In the drawing, the outlined arrows in the circuit diagram on the left side indicate voltage or current. Graphs on the right side of the drawing illustrate variation of voltage or current which are illustrated with the outlined arrows, or operation waveform of each device.

First, the control circuit 40 decides which AC power supply 2 to use between the two AC power supplies 2(1) and 2(2). In the present embodiment, as an example, the control circuit 40 decides to use the AC power supply 2(1) which is sound, as a power supply. The graph Vᵢₙ(1) of the drawing illustrates voltage supplied from the AC power supply 2(1).

Next, the control circuit 40 controls the positive-side control terminal Th11 and the negative-side control terminal Th21 of the rectifying circuit 30(2), in order to block forward direction conduction in the positive-side rectifier Th1(2) and the negative-side rectifier Th2(2) of the rectifying circuit 30(2) which inputs AC power from the AC power supply 2(2) that is not to be used. For example, the control circuit 40 may turn off gates of the positive-side rectifier Th1(2) and the negative-side rectifier Th2(2).

Also, in order to cause forward direction conduction in each of the positive-side rectifier Th1 and the negative-side rectifier Th2 of the rectifying circuit 30(1) to which power is supplied from the AC power supply to use, the control circuit 40 controls the positive-side control terminal Th11 and the negative-side control terminal Th21 of the rectifying circuit 30(1). Thereby, voltage and current illustrated in the graphs Vᵢₙ(1) and Iᵢₙ(1) in the drawing are supplied from the AC power supply 2(1).

For example, as illustrated with the bold solid line arrows and the bold dotted line arrows on the left side of the drawing, and the graphs Vᵢₙ(1) and Th1(1) on the right side of the drawing, in order to cause forward direction conduction in the positive-side rectifier Th1(1) in at least a part of a period in which polarity of the AC power supply to use is a positive voltage, the control circuit 40 controls the positive-side control terminal Th11 of the rectifying circuit 30(1). The control circuit 40 controls the positive-side control terminal Th11, in order to block forward direction conduction in the positive-side rectifier Th1 in at least a part of a period in which polarity of the AC power supply voltage to use is a positive voltage. For example, simply by turning a gate on only at the beginning of a period in which it is a positive voltage, Iᵢₙ(1) becomes zero at zero cross where polarity of an AC power supply voltage shifts to negative, and Th11 is turned off completely at this point of time. In the present embodiment, as an example, the control circuit 40 turns the positive-side control terminal Th11 on over the entire period in which AC voltage is a positive voltage, and turns the positive-side control terminal Th11 off over the entire period in which AC voltage is a negative voltage. Although this increases large power consumption, the control circuit 40 may maintain on-state of the positive-side control terminal Th11 regardless of the positive/negative polarity of the AC voltage.

Also, as illustrated with the thin solid line arrows and the thin dotted line arrows on the left side of the drawing, and the graphs Vᵢₙ(1) and Th2(1) on the right side of the drawing, in order to cause forward direction conduction in the negative-side rectifier Th2(1) in at least a part of a period in which power of the AC power supply to use is a negative voltage, the control circuit 40 controls the negative-side control terminal Th21. The control circuit 40 may control the negative-side control terminal Th21 in order to block forward direction conduction in the negative-side rectifier Th2(1) in at least a part of a period in which AC power to use is a positive voltage. For example, simply by turning a gate on only at the beginning of a period in which it is a negative voltage, Iᵢₙ(1) becomes zero at zero cross where polarity of an AC power supply voltage shifts to positive, and Th21 is turned off completely at this point of time. In the present embodiment, as an example, the control circuit 40 turns the negative-side control terminal Th21 on over the entire period in which AC voltage is a negative voltage, and turns the negative-side control terminal Th21 off over the entire period in which AC voltage is a positive voltage. Although this causes large power consumption, the control circuit 40 may maintain on-state of the negative-side control terminal Th21 regardless of the positive/negative polarity of the AC voltage.

Also, the control circuit 40 controls the positive-side semiconductor switch Q1 and the negative-side semiconductor switch Q2.

For example, as illustrated with the graphs Q1 and Q2 on the right side of the drawing, the control circuit 40 turns the negative-side semiconductor switch Q2 off and turns the positive-side semiconductor switch Q1 on/off in the entire period in which AC power supply voltage to use is a positive voltage. If the positive-side semiconductor switch Q1 is turned on, as illustrated with the bold solid arrows on the left side of the drawing, current from the AC power supply 2(1) flows in order of the positive-side rectifier Th1(1), the positive-side inductor L1, the positive-side semiconductor switch Q1, the middle point between the positive-side capacitor Cd1 and the negative-side capacitor Cd2, and the AC power supply 2(1). Voltage of the AC power supple(1) is applied to the positive-side inductor L1 and current of the positive-side inductor L1 increases. If the positive-side semiconductor switch Q1 is turned off, as illustrated with the bold dotted line arrows on the left side of the drawing, and the graph Vui on the right side of the drawing, current from the AC power supply 2(1) flows in order of the positive-side rectifier Th1(1), the positive-side inductor L1, the positive-side diode D1, the positive-side capacitor Cd1, the middle point between the positive-side capacitor Cd1 and the negative-side capacitor Cd2, and the AC power supply 2(1) to transmit energy of the positive-side inductor L1 to the positive-side capacitor Cd1. As illustrated in the graph I_{L1} on the right side of the drawing, voltage difference between a voltage of the positive-side capacitor Cd1 and a voltage of the AC power supply 2(1) (the voltage in the opposite direction from when the positive-side semiconductor switch Q1 is on) is applied to the positive-side inductor L1 and its current decreases. The control circuit 40 may control on/off time ratio of the positive-side semiconductor switch Q1 to control current from the AC power supply 2(1) to any instantaneous values, and to set end-to-end voltage of the positive-side capacitor Cd1 to any values higher than a voltage peak value of the AC power supply 2(1).

Similarly, the control circuit 40 may turn the positive-side semiconductor switch Q1 off and turn the negative-side semiconductor switch Q2 on/off in a period (the entire period as an example, in the present embodiment) in which AC power to use is a negative voltage. Thereby, end-to-end voltage of the negative-side capacitor Cd2 is set to any values higher than a voltage peak value of the AC power supply 2(1), as an example, the same voltage as that of the positive-side capacitor 1.

From the above, AC power from the AC power supply 2(1) is converted into DC power and held in the positive-side capacitor Cd1 and the negative-side capacitor Cd2, to output from the positive-side output-terminal 101 and the negative-side output-terminal 102.

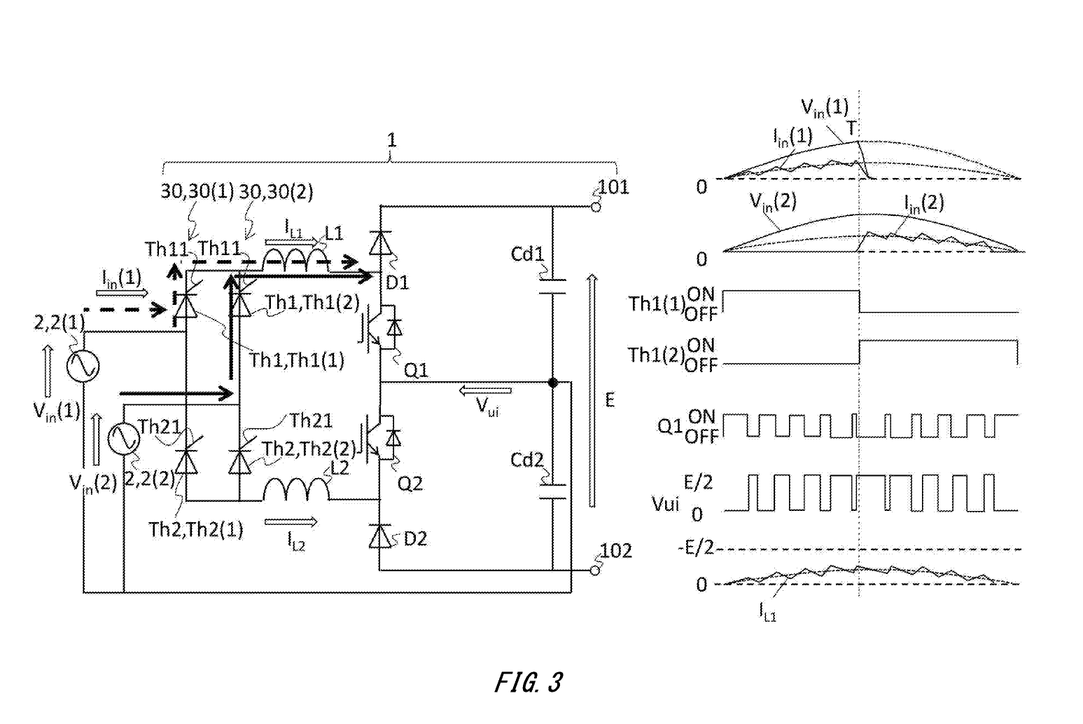

Next, operations of the power supply device 1 in a situation where the AC power supply 2 to use is switched will be described. In the present exemplary operations, as an example, the AC power supply 2(1) and the AC power supply 2(2) may be power supplies of the same type having the same voltage, current, frequencies and phases. FIG. 3 illustrates operations of the power supply device 1 in a situation where the AC power supply 2 to use is switched.

First, at switch timing T of when using the AC power supply 2(1), the control circuit 40 controls the positive-side control terminal Th11 and the negative-side control terminal Th21 of the rectifying circuit 30(1), in order to block forward direction conduction in the positive-side rectifier Th1(1) and the negative-side rectifier Th2(1) of the first rectifying circuit 30(1). In the present embodiment, at the switch timing T, because polarity of the voltage of the AC power supply 2(1) is positive, only the positive-side control terminal Th11 may be switched off at the point of time in which occurrence of an abnormal voltage of the AC power supply 2(1) is sensed. Thereby, if a power failure or the like happens to the AC power supply 2(1), supply of power is blocked spontaneously at the point of time in which current from the AC power supply 2(1) becomes zero. Thus, as illustrated with the graph Iᵢₙ(1) in the drawing, supply of current from the AC power supply 2(1) stops. Note that, even if the positive-side control terminal Th11 and the negative-side control terminal Th21 are on/off controlled simultaneously, in the present embodiment, short-circuit does not occur between AC power supplies. Also, if polarity of the AC power supply 2(1) and the AC power supply 2(2) are positive and negative respectively, the positive-side control terminal Th11 and the negative-side control terminal Th21 are on/off controlled. In this case also, in the present embodiment, short-circuit does not occur between the AC power supplies. Thus, even if polarities, frequencies, phases, etc. of the AC power supplies are not synchronized with each other, it is possible to switch the AC power supply to use for power supply without interruption.

Also, the control circuit 40 controls the positive-side control terminal Th11 and the negative-side control terminal Th21 of the second rectifying circuit 30(2), in order to cause a forward direction conduction state in the positive-side rectifier Th1(2) and the negative-side rectifier Th2(2) of the rectifying circuit 30(2). The control circuit 40 may control the rectifying circuit 30(2), in a similar manner as the control of the rectifying circuit 30(1) when using the AC power supply 2(1) at sound state. Thereby, AC power to use and its path are switched from those illustrated with the dotted line arrows on the left side of the drawing to those illustrated with the solid arrows on the left side of the drawing. In the present exemplary operations, because phases of the AC power supplies 2(1) and 2(2) are the same, as illustrated with graphs Vᵢₙ(1), Vᵢₙ(2), Iᵢₙ(1) and Iᵢₙ(2) in the drawing, the AC power to use is switched while AC power to be inputted to the rectifying circuit 30(1) and 30(2) are synchronized.

Next, the control circuit 40 controls the positive-side semiconductor switch Q1 and the negative-side semiconductor switch Q2 in a similar manner as the control at sound state.

In the present exemplary operations, as an example, the switch timing T may not be synchronized with the phases of the AC power supplies 2(1) and 2(2). For example, the switch timing T may be decided independently of the phases of the AC power supplies 2(1) and 2(2). Note that, the switch timing T may also be synchronized with the phases of the AC power supplies 2(1) and 2(2). For example, the switch timing T may be timing at which voltages Vᵢₙ(1) and Vᵢₙ(2) of the AC power supplies 2(1) and 2(2) cross zero.

The switch timing T is timing at which, as illustrated with graph Vᵢₙ(1) in the drawing, abnormality (as an example, a power failure in the present embodiment) occurs to the AC power supply 2(1) that is being used. In this case, the control circuit 40 switches the AC power supply to use from the AC power supply 2(1) to the AC power supply 2(2) in response to the abnormality occurring to the AC power supply 2(1). For example, the control circuit 40 senses that the voltage Vᵢₙ(1) of the AC power supply 2(1) drops, and switches the AC power supply 2 so that a power failure state does not occur. As an example, the control circuit 40 may switch the AC power supply 2 in response to the voltage Vᵢₙ(1) dropping below a threshold value. The threshold value may be, for example, a value that is 90% of a voltage or current at sound state. The control circuit 40 may sense that a voltage or current drops at any position within the power supply device 1, and may switch the AC power supply 2. As an example, the control circuit 40 may sense a voltage or current between the AC power supply 2 and the corresponding rectifying circuit 30, or may sense on positive-side output-terminal 101 or negative-side output-terminal 102 side relative to the rectifying circuit 30. If voltage or current is sensed on positive-side output-terminal 101 or negative-side output-terminal 102 side relative to the rectifying circuit 30, the control circuit 40 may also sense which of the AC power supplies 2(1) or 2(2) the sensed voltage or current originates from.

In addition to/instead of this, the switch timing T may be timing at which variation of a characteristic of AC power from respective AC power supplies 2 exceeds a threshold value. In this case, the control circuit 40 may switch AC power to use based on characteristics of AC power to be inputted to each of the two rectifying circuits 30(1) and 30(2). For example, in response to voltage of the AC power supply 2(1) that is the one being used between the AC power supplies 2(1) and 2(2) dropping below a low threshold value, and/or in response to voltage of the AC power supply 2(2) which is not being used exceeding a high threshold value, the control circuit 40 may switch an AC power supply to use from the AC power supply 2(1) to the AC power supply 2(2). In this case, the more an current amount becomes less even though supplied power is the same before and after the switching, the more loss is reduced at semiconductor devices and can improve energy efficiency. The low threshold value and the high threshold value may be the same value, or may be different values. As an example, by making the high threshold value greater than the low threshold value, switch operations may have hysteresis.

In addition to/instead of this, the switch timing T may be predetermined timing (as an example, periodical timing). In this case, the control circuit 40 may switch the AC power supply 2 to use based on predetermined schedules. Such schedules may be, for example, schedules to equalize usage of the AC power supplies 2(1) and 2(2). As an example, they may be schedules to switch usage target between the AC power supplies 2(1) and 2(2) every few days or few months.

According to the above described operations, if the AC power supply 2 to use is switched, the positive-side control terminal Th11 and the negative-side control terminal Th21 of the rectifying circuit 30(1) are controlled in order to block forward direction conduction in the positive-side rectifier Th1(1) and the negative-side rectifier Th2(1) of the first rectifying circuit 30(1), and the positive-side control terminal Th11 and the negative-side control terminal Th21 of the second rectifying circuit 30(2) are controlled in order to cause a forward direction conduction state in the positive-side rectifier Th1(2) and the negative-side rectifier Th2(2) of the rectifying circuit 30(2). Accordingly, as well as stopping supply of AC power before the switching, supply of AC power after the switching can be initiated.

Also, because the AC power supply 2 to use is switched asynchronously with the phases of the AC power supplies 2(1) and 2(2), the switching can be performed without waiting for synchronized timing. Accordingly, if power is switched in response to occurrence of abnormality, instantaneous interruption of power supply can be prevented.

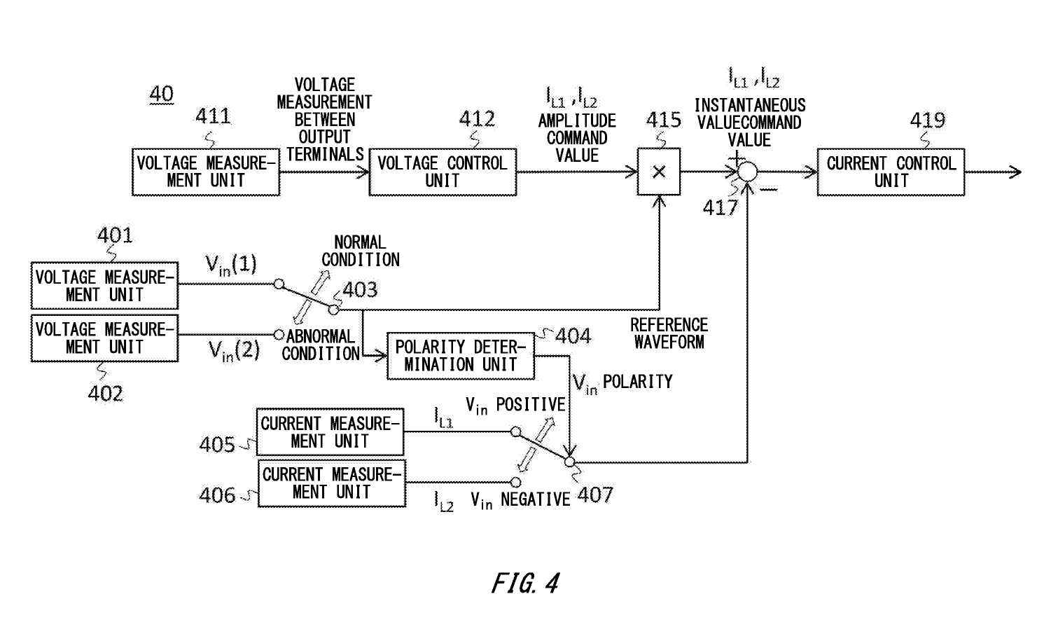

Next, the control circuit 40 will be described. FIG. 4 illustrates the control circuit 40 according to the present embodiment.

The control circuit 40 controls at least one of, end-to-end voltage of the positive-side capacitor Cd1 and the negative-side capacitor Cd2 and current flowing through the positive-side inductor L1 or the negative-side inductor L2. The control circuit 40 has a voltage measurement unit 401 and 402, a switch 403, a polarity determination unit 404, a current measurement unit 405 and 406, a switch 407, a voltage measurement unit 411, a voltage control unit 412, a multiplier 415, a subtractor 417 and a current control unit 419.

The voltage measurement unit 401 measures the voltage Vᵢₙ(1) of the AC power supply 2(1). The voltage measurement unit 401 may measure the voltage Vᵢₙ(1) by using voltage sensors. The voltage measurement unit 401 provides the switch 403 with measurement results.

The voltage measurement unit 402 measures the voltage Vᵢₙ(2) of the AC power supply 2(2). The voltage measurement unit 402 may measure the voltage Vᵢₙ(2) by using voltage sensors. The voltage measurement unit 402 provides the switch 403 with measurement results.

The switch 403 selects AC power to use between AC power from the AC power supplies 2(1) and 2(2). In the present embodiment, as an example, the switch 403 selects AC power of the AC power supply 2(1) at sound state, and selects AC power of the AC power supply 2(2) when abnormality occurs. The switch 403 provides the polarity determination unit 404 and the multiplier 415 with measurements of the selected AC power.

The polarity determination unit 404 determines polarity (the positive/negative polarity of voltage) of the AC power selected by the switch 403. The polarity determination unit 404 provides the switch 407 with discrimination results.

The current measurement unit 405 measures current I_{L1} flowing through the positive-side inductor L1. The current measurement unit 405 may measure the current I_{L1} by using current sensors. The current measurement unit 405 provides the switch 407 with measurements of the current I_{L1}.

The current measurement unit 406 measures current I_{L2} flowing through the negative-side inductor L2. The current measurement unit 406 may measure the current I_{L2} by using current sensors. The current measurement unit 406 provides the switch 407 with measurements of the current I_{L2}.

The switch 407 selects, in response to discrimination results of the polarity determination unit 404, one of the measurements I_{L1} and I_{L2} of current. For example, the switch 407 selects measurements I_{L1} if voltage of AC power to use is positive; in other words, if current flows through the positive-side inductor L1. The switch 407 selects measurements I_{L2} if voltage of AC power to use is negative; in other words, if current flows through the negative-side inductor L2.

The voltage measurement unit 411 measures voltage between the positive-side output-terminal 101 and the negative-side output-terminal 102. The voltage measurement unit 411 may measure voltage by using voltage sensors. The voltage measurement unit 411 provides the voltage control unit 412 with measurement results.

The voltage control unit 412 calculates an amplitude command value of the current I_{L1} or I_{L2} of the inductor L1 or L2, from measurements of voltage. The multiplier 415 multiplies this amplitude command value and an instantaneous value of input voltages Vᵢₙ(1) or Vᵢₙ(2) to obtain an instantaneous current command value with similar waveform to input voltage. The current control unit 419 on-off controls the positive-side semiconductor switch Q1 or the negative-side semiconductor switch Q2, such that the measurement of current I_{L1} or I_{L2} match with the instantaneous current command value. As current increases when it is on and decreases when it is off, this time ratio control realizes the above-mentioned control.

Next, a modification example of the present embodiment will be described. In the present modification, the AC power supply 2(1) and the AC power supply 2(2) are not synchronized, and phase difference is occurring therebetween. The drawing illustrates when 180° of phase shift is occurring.

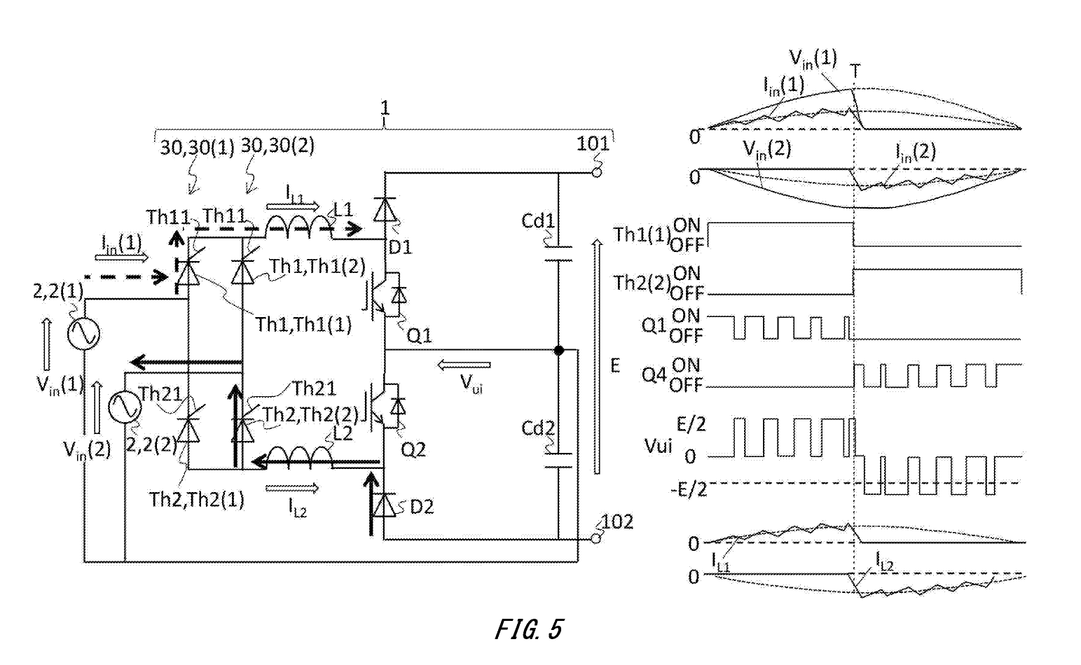

Next, in the present modification, operations of the power supply device 1 in a situation where the AC power supply 2 to use is switched will be described. FIG. 5 illustrates operations of the power supply device 1 in a situation where the AC power supply 2 to use is switched. In the modification example, identical reference numerals are used to denote elements having substantially the same configuration as those illustrated in FIG. 1, and description of them is omitted.

First, at switch timing T of when using the AC power supply 2(1), the control circuit 40 controls the positive-side control terminal Th11 and the negative-side control terminal Th21 of the first rectifying circuit 30(1) in order to block forward direction conduction in the positive-side rectifier Th1(1) and the negative-side rectifier Th2(1) of the first rectifying circuit 30(1). Thereby, power supply from the AC power supply 2(1) stops. The switch timing T may be synchronized with the phases of one of the AC power supplies 2(1) and 2(2), or may not be synchronized with it. In the present exemplary operations, as an example, as illustrated with the graph Vᵢₙ(1) in the drawing, the switch timing T may be timing at which abnormality has occurred to the AC power supply 2(1) being used, or may also be timing at which AC power of the AC power supply 2(1) is positive voltage and AC power of AC power supply 2(2) is negative voltage.

Also, the control circuit 40 controls the positive-side control terminal Th11 and the negative-side control terminal Th21 of the second rectifying circuit 30(2) in order to cause a forward direction conduction state in the positive-side rectifier Th1(2) and the negative-side rectifier Th2(2) of the second rectifying circuit 30(2). The control circuit 40 may control the rectifying circuit 30(2) in a similar manner as the control of the rectifying circuit 30(1) when using the AC power supply 2(1) at sound state. In the present exemplary operations, because the phases of the AC power supplies 2(1) and 2(2) are 180° different from each other, and AC power of the AC power supply 2(1) is positive voltage and AC power of the AC power supply 2(2) is negative voltage at the switch timing T, the positive-side rectifier Th(1) of the rectifying circuit 30(1) is switched from on to off, and the negative-side rectifier Th(2) of the rectifying circuit 30(2) is switched from off to on at the switch timing T. Thereby, AC power to use is switched from that illustrated with the dotted line arrows to that illustrated with the solid arrows on the left side of the drawing, to change flow of current.

Next, the control circuit 40 controls the positive-side semiconductor switch Q1 and the negative-side semiconductor switch Q2 in response to the positive/negative polarity of voltage supplied before and after the switching. In the present exemplary operations, as described above, the phases of the AC power supplies 2(1) and 2(2) are 180° different from each other, and AC power of the AC power supply 2(1) is positive voltage and AC power of the AC power supply 2(2) is negative voltage at the switch timing T. Therefore, at the switch timing T, control to turn off the negative-side semiconductor switch Q2 and to turn on/off the positive-side semiconductor switch Q1 is switched to control to turn off the positive-side semiconductor switch Q1 and to turn on/off the negative-side semiconductor switch Q2. Thereby, as illustrated with the graphs I_{L1} and I_{L2} on the right side of the drawing, a state in which the positive-side capacitor Cd1 holds DC power that originates from the AC power supply 2(1) and flows via the positive-side inductor L1 is switched to a state in which the negative-side capacitor Cd2 holds DC power that originates from the AC power supply 2(2) and flows via the negative-side inductor L2.

According to the above described exemplary operations, if a usage target is switched from the AC power supply 2(1) to the AC power supply 2(2) at the switch timing T at which the AC power supply 2(1) is positive voltage and the AC power supply 2(2) is negative voltage, current can flow from the positive-side rectifier Th1 to the positive-side inductor L1 until AC voltage from the AC power supply 2(1) becomes zero even if gates of the positive-side rectifier Th1(1) and the negative-side rectifier Th2(1) of the rectifying circuit 30(1) are turned off. However, short-circuit paths are not formed even if the positive-side rectifier Th2(1) and the negative-side rectifier Th2(2) of the rectifying circuit 30(2) are conducted in forward direction in order to allow current from the AC power supply 2(2) to flow at this point of time. Hence, because there is no need to delay power supply from the AC power supply 2(2) in order to prevent a short-circuit, it is possible to maintain power supply without instantaneous interruption. Note that, power supply may be received from both the AC power supplies 2(1) and 2(2), by temporarily conducting in forward direction, the positive-side rectifier Th1(1) and the negative-side rectifier Th2(1) of the rectifying circuit 30(1), and the positive-side rectifier Th2(1) and the negative-side rectifier Th2(2) of the rectifying circuit 30(2) respectively. Current flowing through the positive-side inductor L1 after a gate of the positive-side rectifier Th1(1) of the rectifying circuit 30(1) is turned off is rapidly decreased by maintaining the positive-side semiconductor switch Q1 off state.

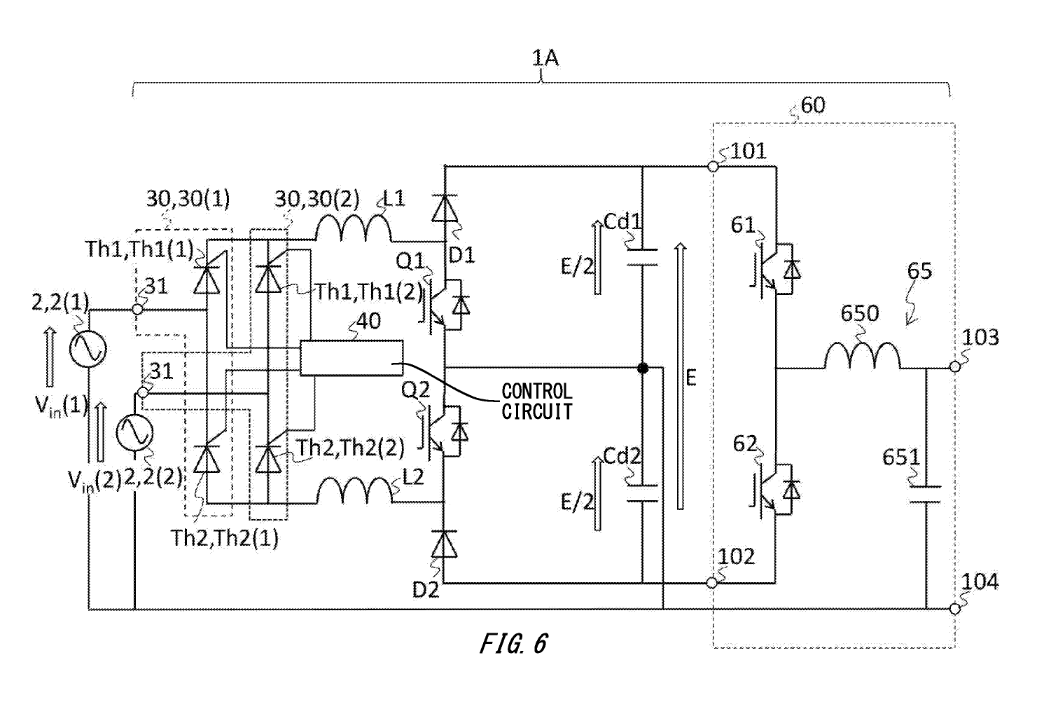

Next, another modification example of the present embodiment will be described. FIG. 6 illustrates power supply device 1A according to the present modification together with two AC power supplies 2. The power supply device 1A may be an uninterruptible AC power supply which maintains supply of AC power by switching the AC power supply 2 to use, and includes a converting circuit 60.

The converting circuit 60 is connected to a positive-side output-terminal 101 and a negative-side output-terminal 102, and converts DC power from the positive-side output-terminal 101 and the negative-side output-terminal 102 into AC power to be outputted. The converting circuit 60 may output AC power from a first output-terminal 103 and a second output-terminal 104. In the present embodiment, as an example, the converting circuit 60 may have a first semiconductor device 61, a second semiconductor device 62, and a LC filter 65.

The first semiconductor device 61 and the second semiconductor device 62 may be sequentially connected in series between the positive-side output-terminal 101 and the negative-side output-terminal 102. The middle point between the first semiconductor device 61 and the second semiconductor device 62 may be connected to the first output-terminal 103.

The LC filter 65 has a inductor 650 and a capacitor 651. The inductor 650 may be provided between the middle point between the first semiconductor device 61 and the second semiconductor device 62 and the first output-terminal 103. The capacitor 651 may be connected between the first output-terminal 103 and the second output-terminal 104. The second output-terminal 104 may be connected to the middle point between a positive-side capacitor Cd1 and a negative-side capacitor Cd2.

A control circuit 40 of the power supply device 1A converts DC power from the positive-side output-terminal 101 and the negative-side output-terminal 102 into two-level AC power to be outputted, by using the converting circuit 60. For example, the control circuit 40 may output two-level AC power from the first output-terminal 103 and the second output-terminal 104 by controlling the first semiconductor device 61 and the second semiconductor device 62 to turn on/off. As an example, the control circuit 40 may alternatively turn on the first semiconductor device 61 and the second semiconductor device 62.

According to the above described power supply device 1A, it is possible to supply AC power without using batteries, even when abnormality occurs.

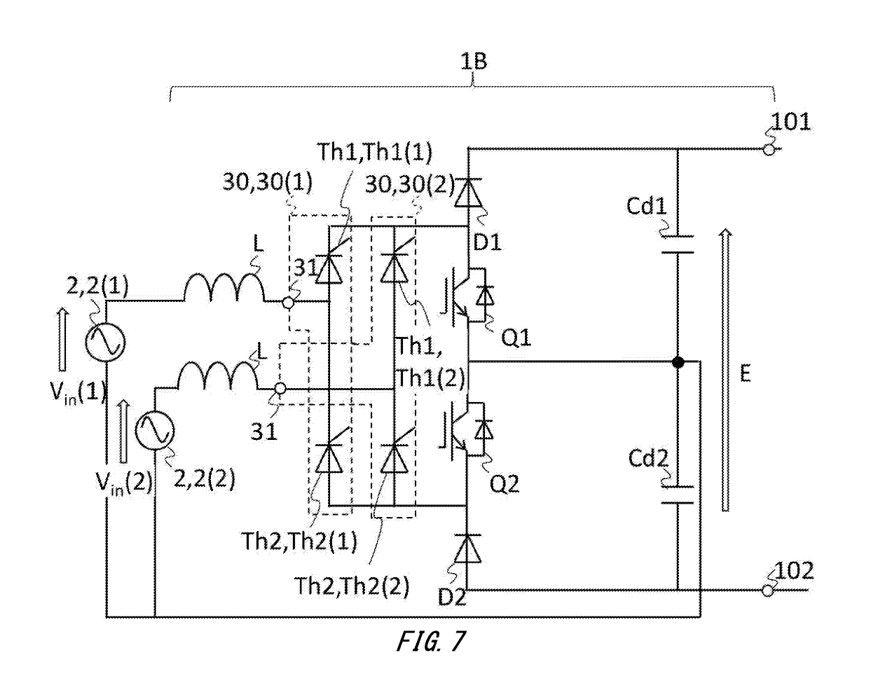

Note that, in the above described embodiments and modification examples, although the positive-side inductor L1 has been described as connected between the two rectifying circuits 30 and the positive-side output-terminal 101, and the negative-side inductor L2 has been described as connected between two rectifying circuits 30 and the negative-side output-terminal 102. In addition to/instead of this, inductors may be provided to other positions. FIG. 7 illustrates a power supply device 1B according to a modification example. As illustrated in this drawing, a inductor L may be provided per rectifying circuit 30, for example. In other words, a inductor L may be provided corresponding to each of a plurality of rectifying circuits 30. Each inductor L may be connected between an AC power supplies 2(1) and 2(2) which correspond to a rectifying circuit 30(1) and 30(2) respectively, and an AC input-terminal 31. In this case, among a plurality of inductors L, a inductor L corresponding to the AC power supply 2 to use is continuously conducted regardless of the positive/negative polarity of voltage, and other inductors L become non-conductive. The inductor L may be an example of an input side inductor.

Also, although the converting circuit 60 has been described as converting DC power into AC power to be outputted, it may convert DC power inputted into different DC power. As an example, the converting circuit 60 may boost DC power inputted.

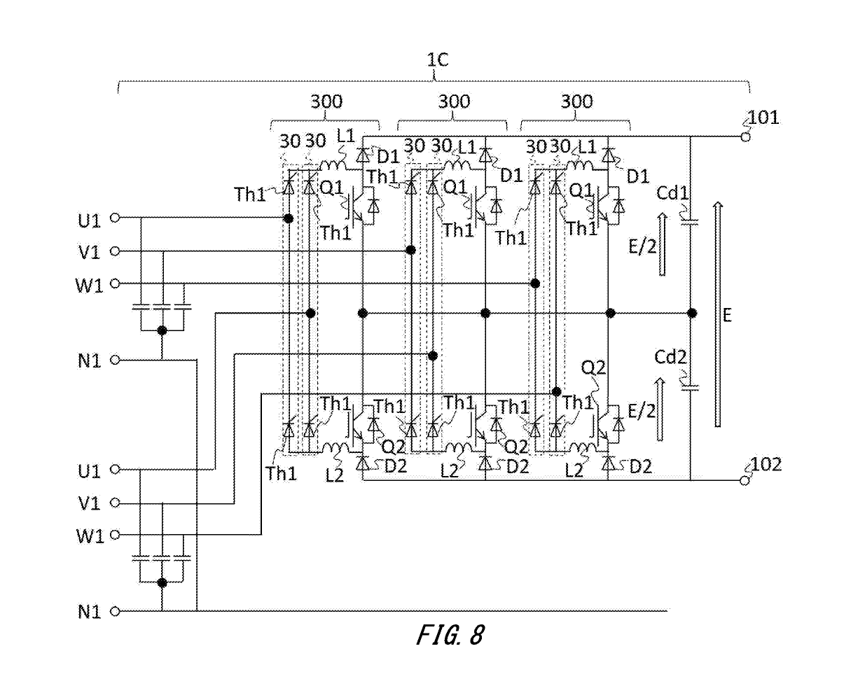

Also, although the power supply device 1 has been described as converting single-phase AC power into DC power, it may convert a plurality of multi-phase AC power into DC power. FIG. 8 illustrates a power supply device 1C according to a modification example. As illustrated in this drawing, for example, the power supply device 1C may be provided with AC power in three-phase four wire systems from a plurality of (two in the present embodiment, as an example) three-phase AC power supplies. The power supply device 1C may include sets 300 of a positive-side semiconductor switch Q1, a negative-side semiconductor switch Q2, and a plurality of rectifying circuits 30, corresponding to each U-phase, V-phase, and W-phase AC power. The power supply device 1C of this drawing may further include a converting circuit 60 connected to a positive-side output-terminal 101 and a negative-side output-terminal 102.

Also, although the positive-side rectifier Th1 and the negative-side rectifier Th2 are described as thyristors, they may be another semiconductor switches such as reverse blocking IGBTs. As described above, because semiconductor devices having self-turn-off capability tend to cause a large loss, it is preferable to use low-loss devices instead.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by a device, system, program, and method shown in the claims, embodiments, or diagrams can be performed in any order unless the order is indicated by “prior to,” “before,” or the like, or unless the output from a previous process is used in a later process. Even if the process flow is described using phrases such as “first” or “next” in the claims, embodiments, or diagrams, it does not necessarily mean that the process must be performed in this order.

As it is obvious from the above-mentioned descriptions, according to (an) embodiment of the present invention, it is possible to appropriately switch to an AC power supply that is to be used, and supply power from this AC power supply without causing instantaneous interruption.

What is claimed is:

1. A power supply device comprising:
a positive-side capacitor and a negative-side capacitor which are sequentially connected between a positive-side output-terminal and a negative-side output-terminal;
a positive-side semiconductor switch and a negative-side semiconductor switch which are sequentially connected between the positive-side output-terminal and the negative-side output-terminal, and are parallel to the positive-side capacitor and the negative-side capacitor; and
a plurality of rectifying circuits, each of which has an AC input-terminal, and rectifies current flowing between the AC input-terminal, and the positive-side output-terminal and the negative-side output-terminal, wherein,
each of the plurality of rectifying circuits has:
a positive-side rectifier which: is connected between the AC input-terminal and the positive-side output-terminal; can control a forward conduction state from the AC input-terminal side toward the positive-side output-terminal side; and blocks reverse current; and
a negative-side rectifier which: is connected between the AC input-terminal and the negative-side output-terminal; can control a forward conduction state from the negative-side output-terminal toward the AC input-terminal; and blocks reverse current.

2. The power supply device according to claim 1, wherein,
each of the plurality of rectifying circuits has a positive-side control terminal to control a forward conduction state of the positive-side rectifier, and a negative-side control terminal to control a forward conduction state of the negative-side rectifier, and
the power supply device further comprising a control circuit to control the positive-side control terminal and the negative-side control terminal of each of the plurality of rectifying circuits.

3. The power supply device according to claim 2, wherein in order to cause forward direction conduction in the positive-side rectifier and the negative-side rectifier of a first rectifying circuit to which, among the plurality of rectifying circuits, AC power to use is inputted, the control circuit controls the positive-side control terminal and the negative-side control terminal of the first rectifying circuit.

4. The power supply device according to claim 3, wherein if AC power to use is switched from a first AC power to be inputted to the first rectifying circuit to a second AC power to be inputted to a second rectifying circuit among the plurality of rectifying circuits, the control circuit controls the positive-side control terminal and the negative-side control terminal of the first rectifying circuit in order to block forward direction conduction in the positive-side rectifier and the negative-side rectifier of the first rectifying circuit, and controls the positive-side control terminal and the negative-side control terminal of the second rectifying circuit, in order to cause a forward direction conduction state in the positive-side rectifier and the negative-side rectifier of the second rectifying circuit.

5. The power supply device according to claim 4, wherein the control circuit switches AC power to use, asynchronously with AC power to be inputted to the first rectifying circuit and AC power to be inputted to the second rectifying circuit.

6. The power supply device according to claim 4, wherein,
the plurality of rectifying circuits inputs AC power from different AC power supplies, and
the control circuit switches AC power to use among some AC power to be inputted to the plurality of rectifying circuits, based on a predetermined schedule.

7. The power supply device according to claim 2, comprising a set of the positive-side semiconductor switch, the negative-side semiconductor switch, and the plurality of rectifying circuits, corresponding to each phase of a plurality of multi-phase AC power.

8. The power supply device according to claim 2, wherein the positive-side rectifier and the negative-side rectifier of each of the plurality of rectifying circuits are thyristors.

9. The power supply device according to claim 2, wherein the control circuit:
controls the positive-side control terminal of a rectifying circuit which inputs AC power to use among the plurality of rectifying circuits, in order to cause forward direction conduction in the positive-side rectifier in at least a part of a period in which the AC power is positive voltage, and in order to block forward direction conduction in the positive-side rectifier in at least a part of a period in which the AC power is negative voltage; and
controls the negative-side control terminal of the rectifying circuit, in order to cause forward direction conduction in the negative-side rectifier in at least a part of a period in which the AC power is negative voltage, and in order to block forward direction conduction in the negative-side rectifier in at least a part a period in which the AC power is positive voltage.

10. The power supply device according to claim 1, comprising:
a positive-side inductor connected between the plurality of rectifying circuits and the positive-side output-terminal; and
a negative-side inductor connected between the plurality of rectifying circuits and the negative-side output-terminal.

11. The power supply device according to claim 1, further comprising an input side inductor which is provided corresponding to each of the plurality of rectifying circuits, and is connected between an AC power supply and the AC input-terminal which correspond to respective rectifying circuits.

12. The power supply device according to claim 1, further comprising a converting circuit connected to the positive-side output-terminal and the negative-side output-terminal, and converts DC power to different DC power or AC power to be outputted from the positive-side output-terminal and the negative-side output-terminal.
